(19) United States
(12) Patent Application Publication
(10) Pub. No.: US 2026/0225650 A1
(43) Pub. Date: Aug. 6, 2026

(54) DEVICE, IN PARTICULAR A STEERING CONTROL UNIT, WITH A MOVABLE OPERATING ELEMENT AND AN ACTUATOR UNIT, AND METHOD FOR OPERATING A DEVICE

(71) Applicant: INVENTUS ENGINEERING GMBH, St. Anton i.M. (AT)

(72) Inventor: Tobias SCHMIDLE, Vandans (AT)

(21) Appl. No.: 19/150,632

(22) PCT Filed: Jan. 22, 2024
(86) PCT No.: PCT/EP2024/051393

§ 371 Date: Jul. 24, 2025

(30) Foreign Application Priority Data
Jan. 24, 2023 (DE) 10 2023 101 620.2
May 11, 2023 (DE) 10 2023 112 530.3

(51) Int. Cl. B62D 6/00

(52) U.S. Cl. CPC B62D 6/008

(57) ABSTRACT

A device with a moveable operating element and an actuator for the targeted influencing of the mobility of the operating element. The actuator has a magnetorheological brake, an electric motor, and a calibrator configured to coordinate the braking torque of the brake and the torque of the motor as part of an automated calibration routine. The calibrator is configured to place the brake in a defined test state, and to generate at least one test torque acting against the brake by the motor, and to register at least one characteristic variable characterizing the effect of the test torque on the mobility of the operating element.

Device, in particular a steering control unit, with a movable operating element and an actuator unit, and method for operating a device

The invention relates to a device, in particular a steering input device, with a movable operating element and with an actuator device for the targeted influencing of the mobility of the operating element. The actuator device comprises at least one magnetorheological braking device and at least one electric motor.

Such devices can be used in a variety of ways, for example as a control button or control lever with haptic feedback or as a steering input device for specifying a steering movement according to the steer-by-wire concept. For example, the brake together with the motor simulates feedback that comes from the chassis in conventional steering systems and can be felt on the steering wheel.

High demands are placed on the interaction between the braking system and the motor in order to enable precise steering feedback and smooth, harmonious steering behavior. Particularly important here is the transition from a torque generated by the motor to a braking torque and vice versa. Often even small deviations lead to noticeable discontinuities or sudden changes in rotational resistance during operation.

A further requirement concerns safety in the event of a malfunction, for example in the event of a power failure or a loss of torque or braking torque (fail-safe case). Because there is no longer any resistance to the steering movement, an unintentional strong steering angle (oversteering) can occur. This results in a very dangerous driving condition.

However, if the steering unit is generally (mechanically) stiff (=high basic torque), it is no longer possible to achieve perfect haptic control in normal operation (active resetting . . . ). Only very smooth-running steering units (preferably <0.1 Nm basic torque of all steer-by-wire steering components) enable haptically sophisticated and harmonious steering movements.

In contrast, the object of the present invention is to provide an improved device which particularly advantageously meets the previously discussed requirements. In particular, a precise interaction between the braking device and the motor should be ensured reliably and as permanently as possible.

This object is achieved by a device having the features of claim 1. A method according to the invention is the subject of claim 23. Preferred developments of the invention are the subject of the subclaims. Further advantages and features of the present invention emerge from the general description and from the description of the exemplary embodiments.

The device according to the invention is in particular a steering input device (for inputting a steering command according to the steer-by-wire concept) and has a (manually and/or motor-driven) movable control element and an actuator device for specifically influencing the mobility of the control element. The actuator device comprises at least one magnetorheological braking device with at least one electrical coil device. The braking device serves to generate a braking torque acting on the control element, so that the mobility of the control element can be specifically braked. The actuator device comprises at least one electric motor (electric motor) for generating an acting torque so that the control element can be actively moved. The device comprises at least one calibration device. The calibration device is suitable and designed to coordinate the braking torque of the braking device and the torque of the motor as part of an automated calibration routine. The calibration device is suitable and designed to put the braking device into a defined test state and (before, during and/or after) to generate at least one (defined) test torque by means of the motor, which counteracts the braking device. The calibration device is suitable and designed to register (and process) at least one parameter which characterizes the effect of the test torque on the mobility of the control element. In particular, the calibration device records the parameter and/or at least one sensor variable characteristic of the parameter by means of a sensor device.

The device according to the invention offers many advantages. A significant advantage is the calibration device with the automated calibration routine. This allows the braking device and the motor to be coordinated precisely and reliably and at the same time very inexpensively. For example, an automated, regular and safe calibration routine is of great importance for a steering control device. It is particularly advantageous that the calibration routine can be carried out regularly during operation or when required, so that the desired coordination of the braking device and motor can be guaranteed over the long service life of the device. A further advantage is that the calibration device can be integrated into an existing device in a space-saving and structurally inexpensive manner. The calibration device can use existing components to carry out the calibration routine.

In particular, the defined test state, in which the braking device is offset by the calibration device, is taken from a group of test states at least comprising: test state for an fault protection device (in particular with an interruption of the power supply for normal operation); test state for an aging test for a magnetorheological medium of the braking device; test state for determining a cancellation coil current for the (maximum) cancellation of an emergency braking torque of an fault protection device (by means of an opposing field); test state for detecting an assignment function and preferably a characteristic curve which describes the relationship between a coil current and the braking torque (which can be generated with the respective coil current).

In an advantageous embodiment, the calibration device is suitable and designed to perform at least the following steps in this or another (executable) order during the calibration routine and preferably during a test for a fault protection device: Bring the motor to a standstill (speed=0) or to a test speed. Activate a test state (for a fault protection device) in which the electrical coil device is in a de-energized state. For the test state, in particular, a fault braking torque is present. In particular, the test state is active while the speed=0 or while the test speed is set. Control the motor to generate a test torque. Check whether the test torque is sufficient to move the control element from standstill or to maintain the test speed. If the test torque is insufficient: (Stepwise) increase the test torque and recheck whether the test torque is sufficient. If the test torque is sufficient: Compare the test torque (which has proven sufficient) with a reference torque. If the test torque exceeds (or reaches) the reference torque: Classify the emergency protection device as OK. If the test torque falls below the reference torque: Classify the emergency protection device as not OK and, in particular, assume a fault. In particular, an error message can be issued and/or the test can be repeated at least once.

In particular, the reference torque for checking whether the control element can be set in motion from a standstill is a different reference torque than for checking whether the test speed can be maintained. In particular, when selecting the reference torque, consideration is given to whether the test is carried out when the motor is at a standstill or when the motor is already rotating.

Preferably, the calibration device is suitable and designed to store the test torque that has proven to be sufficient (to overcome the effect of the braking device) and in particular also exceeds the reference torque, in a memory and to compare the test torques stored in the memory with one another as part of long-term monitoring. In particular, the calibration device can thereby record a trend of a temporal change in the emergency braking torque. This means that, for example, a service can be planned or suggested in good time so that unexpected operational failures can be avoided.

When, in the context of the present invention, reference is made to the storage or registration of a current or a torque or braking torque, this refers to a numerical value (and not to the storage of the current as such).

It is advantageous and preferred that the calibration device is suitable and designed to carry out at least the following steps in this or another (executable) order during the calibration routine and preferably during a test for the aging of a magnetorheological medium of the braking device: Bring the motor to a standstill (speed=0) or to a test speed. Activation of a test state (for an ageing test) in which the electrical coil device is energized with a defined test coil current. In particular, this results in a test braking torque. In particular, the test state is active while the speed=0 or while the test speed is set. Controlling the motor to generate a test torque. Checking whether the test torque is sufficient to set the control element in motion from a standstill or to maintain the test speed. If the test torque is not sufficient: (step by step) 11 increasing the test torque and checking again whether the test torque is sufficient. If the test torque is sufficient: comparing a test parameter which corresponds to the test torque (which has proven to be sufficient) and/or a parameter calculated from the test torque and e.g. the braking torque, with at least one comparison parameter. If the test parameter exceeds (or reaches) the comparison parameter: classifying the condition (ageing condition) of the braking device as OK. If the test parameter falls below the comparison parameter: classify the condition (ageing condition) of the braking device as not OK and in particular correct the control of the coil device with a compensation parameter and/or assume a fault. In particular, an error message can be issued and/or the test can be repeated at least once.

Preferably, the calibration device is suitable and designed to store the test parameters in a memory and to compare the test parameters stored in the memory with one another as part of long-term monitoring. In particular, the calibration device can detect and monitor a trend in the aging of the medium or other signs of wear of the braking device. It is possible and advantageous for the calibration device to increase or decrease the frequency of the tests depending on the trend. The calibration device is preferably suitable and designed to determine at least one compensation parameter depending on the test parameter and to control the electrical coil device (in the future) taking the compensation parameter into account. The compensation parameter preferably corrects a relationship between a coil current and the braking torque (which can be generated with the respective coil current). In particular, the compensation parameter ensures that the coil current required for the requested braking torques is increased. To do this, the calibration device can, for example, access a control device in which the relationship between coil current and braking torque is stored and correct this relationship with the compensation parameter. For example, the compensation parameter is an absolute value, a factor or a function.

The device preferably comprises at least one fault protection device with at least one permanent magnet device. In particular, the permanent magnet device provides a magnetic field which serves to generate an emergency braking torque acting on the operating element. The magnetic field of the permanent magnet device acts in particular on the magnetorheological medium of the braking device (arranged in the gap of the braking device). In particular, the magnetic field of the permanent magnet device can be reduced in normal operation by a magnetic counterfield of the electrical coil device, so that the emergency braking torque is at least partially canceled. In particular, the counterfield can be generated by controlling the coil device (by the control device and/or the calibration device) with a defined cancellation coil current. Such an fault protection device has the advantage that, despite a power failure or a de-energized coil device, the operating element cannot be turned without resistance. In particular, the emergency protection device is suitable and designed to apply a targeted emergency braking torque to the mobility of the control element at least in the event of a failure of the braking device and/or in the event of a failure of the motor. In this way, the control element is neither blocked nor can it be moved without resistance.

It is preferred and advantageous that the calibration device is suitable and designed to set a plurality of different counterfield coil currents during the calibration routine and preferably during a test to determine the cancellation coil current and to iteratively determine and register a test torque for each of the set counterfield coil currents at which the control element is set in motion from a standstill or at which the test speed is maintained. In particular, the calibration device is suitable and designed to determine from the set counterfield coil currents and the test torques registered for each of them the counterfield coil current at which the lowest test torque is present and to register this counterfield coil current as the cancellation coil current. In particular, the cancellation coil current corresponds to a counterfield coil current at which the emergency braking torque is maximally reduced or canceled. In particular, the lowest test torque determined is assumed to be the maximum reduction in the emergency braking torque. A (maximum) cancellation is understood to mean in particular the greatest possible cancellation that can be implemented in accordance with operational requirements within the scope of the device and its calibration.

Preferably, the calibration device is suitable and configured to register the test torque present at the cancellation coil current as the base torque. For this purpose, the value of the lowest test torque determined during the test to determine a cancellation coil current can be used. However, a further calibration routine can also be performed in which the (previously determined and registered) cancellation coil current is set and then the 8 test torque is determined and registered at which the 9 control element is set in motion from a standstill or at which the test speed is maintained. This test torque is then registered as the base torque.

In particular, the calibration device provides the cancellation coil current and/or the base torque to the control device. In particular, the control device takes the cancellation coil current and/or the base torque into account when setting braking torques during normal operation. In particular, the control device takes the cancellation coil current and/or the base torque into account when creating and/or adapting the assignment function or the characteristic curve. For example, a required target braking torque is to be set during operation. The control device can then take into account that in order to generate the target braking torque it must set a braking torque which corresponds to the target braking torque minus the base torque. Preferably, the control device can take the cancellation coil current into account when setting the coil current for the purpose of generating a target braking torque.

Preferably, the calibration device is suitable and designed to increase the counter-field coil current, step by step, starting from an initial value and to determine a test torque for each increased counter-field coil current and to repeat this iteration as long as the determined test torques decrease. Preferably, the calibration device is suitable and designed to end this iteration when at least once a test torque is determined that is higher than the previously determined test torque (defined). In particular, after the iteration has ended, the lowest test torque is selected. The counter-field coil current which was set at this test torque is then preferably registered as the cancellation coil current.

In an advantageous embodiment, the calibration device is suitable and designed to perform at least the following steps in this or another (executable) order: In particular, setting the initial value of the counter-field coil current to 0 amperes or to another defined initial value. Bringing the motor to a standstill (speed=0) or to a test speed. In particular, the test state is active while the speed=0 or while the test speed is set. Controlling the motor to generate a test torque. Checking whether the test torque is sufficient to move the control element from a standstill or to maintain the test speed. If the test torque is insufficient: (Stepwise) increasing the test torque and rechecking whether the test torque is sufficient. If the test torque is sufficient and this is the first test torque determined: Iterate with a defined increase in the counter-field coil current until at least two test torques are determined. If the test torque is sufficient and not the first test torque determined: Check whether the test torque is smaller than a test torque determined immediately before. If the test torque is smaller than the test torque determined immediately before: Record the test torque value and the corresponding counter-field coil current and iterate at least some of the previous steps of the calibration routine with a defined increase in the counter-field coil current. If the test torque is greater than the immediately previously determined test torque: discard the currently determined test torque and record the previously determined test torque as the (minimum) base torque (of the actuator device) with the associated counter-field coil current as the cancellation coil current, and end the iteration. In particular, the base torque corresponds to a minimum braking torque that remains when the fault braking torque (due to the counter-field of the coil device) is canceled.

In particular, the base torque and/or the cancellation coil current can be stored in a memory. In particular, the base torque and/or the cancellation coil current can be taken into account when controlling the motor and/or the braking device. For example, a compensation parameter or the like can be determined from the base torque and/or the cancellation coil current. This means that the motor can be controlled in such a way that the base torque is overcome or is not noticeable in normal operation.

Preferably, the calibration device is suitable and designed to register the cancellation coil current and to use it at least partially to cancel the emergency braking torque in normal operation. The cancellation coil current can be used directly as a setpoint for the coil current. It is also possible for the cancellation coil current to be calculated into a setpoint using a correction parameter and for the setpoint to then specify the coil current for generating the opposing field.

Preferably, the calibration device is suitable and designed to store the cancellation coil current in a memory and to compare the cancellation coil currents stored in the memory with one another as part of long-term monitoring. In particular, the calibration device can detect and monitor a trend for the development of the permanent magnet device or other signs of wear of the braking device.

In an advantageous and preferred embodiment, the calibration device is suitable and designed to perform at least the following steps in the calibration routine in this or another (executable) order: Bring the motor to a standstill (speed=0) or to a test speed. Activate a test state in which the electrical coil device is energized with a defined test coil current, so that a defined test braking torque is present. In particular, the test state is active while the speed=0 or while the test speed is set. Control the motor to generate a test torque. Check whether the test torque is sufficient to move the control element from a standstill or to maintain the test speed. If the test torque is insufficient: (Stepwise) increase the test torque and recheck whether the test torque is sufficient. If the test torque is sufficient: Use the test torque to create and/or adapt and/or check an assignment function that describes the relationship between a coil current and the braking torque (that can be generated with the respective coil current).

By creating or adapting the assignment function in this way, it can be ensured that the braking device is optimally controlled and can precisely provide the required braking torque in normal operation. At the same time, the braking device and the motor can be optimally coordinated with one another.

In particular, the creation and/or adaptation and/or verification of the assignment function is carried out based on the assumption that a braking torque can be generated with the test coil current that at least approximately corresponds to the test torque of the motor. In particular, based on the assignment function, an algorithm stored in the calibration device can be used to calculate which coil current must be set in order to generate a desired braking torque.

Preferably, the calibration device is suitable and designed to gradually increase the test braking torque of the electrical coil device and for the set test braking torques, an iteration of at least some of the previous steps of the calibration routine is to be carried out (i.e. for each increase in the test braking torque). In particular, during the iteration, at least the steps for checking whether the test torque is sufficient and the steps which are provided as a consequence of the result of the check are repeated. In other words, for each test braking torque used in the test, a test torque is determined at which the control element can be set in motion from a standstill or at which the test speed can be maintained.

In particular, a test braking torque and an associated test torque are registered for each iteration. Preferably, the calibration device is suitable and designed to register a large number of test braking torques and respective associated test torques and to determine a characteristic curve from them. In particular, the characteristic curve describes the relationship between the coil current and the braking torque (which can be generated with the respective 27 coil current). In particular, the characteristic curve is made available to the control device. In particular, the control device can determine from the characteristic curve which coil current is necessary to generate a required braking torque.

In particular, the iteration is carried out until a maximum motor torque is reached. It is also possible for the iteration to end before the maximum motor torque is reached. Preferably, the calibration device and/or the control device is suitable and configured to extend the assignment function and/or the characteristic curve using an algorithm such that coil currents can also be calculated with which braking torques greater than the maximum motor 8 torque can be generated. In other words, the algorithm can be used to calculate coil currents that have not been tested or calibrated due to the limited motor power. In particular, the maximum braking torque is higher than the maximum motor torque.

The calibration device is preferably suitable and designed to store the allocation function and preferably the characteristic curve in a memory and to compare allocation functions or characteristic curves stored in the memory with one another as part of long-term monitoring. In particular, the calibration device can thereby record a trend of a temporal change in the allocation functions or characteristic curves and carry out a status assessment of the braking device.

In an advantageous further development, the calibration device is suitable and designed to use the allocation function and preferably the characteristic curve to calculate compensation functions. In particular, the calibration device can adapt the allocation function or the characteristic curve to compensate for (functional and/or temporal) changes in the braking device. It is possible and advantageous for the calibration device to use the results of the various tests to calculate the compensation functions.

In all embodiments, it is particularly preferred that the calibration device is suitable and designed to adjust at least one control variable (e.g. the assignment function and/or characteristic curve) based on the data recorded during the calibration routine. In particular, the control variable is stored in a control device. In particular, the control variable is used to control the actuator device (the braking device and/or the motor). The calibration routines presented here can therefore be used to particularly reliably ensure that the control device always controls the braking device with an optimal control variable.

In particular, the calibration device is suitable and designed to determine the torque provided by the engine by means of a (motor-specific) allocation function. In particular, the allocation function describes the relationship between a motor current and the torque that can be provided by the motor with the respective motor current. The allocation function can include a torque constant specific to the motor or can be provided by such a constant. It is also possible for the calibration device to detect the torque provided by the motor using a sensor device.

It is possible and advantageous that the calibration device is suitable and designed to automatically carry out the calibration routine depending on a trigger parameter. In particular, the trigger parameter is taken from a group of trigger parameters, at least comprising: operating state of the device; start and/or termination of an operation and/or a function of the device; time; interval; number of operating hours; presence of a fault; command from a control device; input command from a user.

In particular, the calibration device is suitable and designed to automatically select which test is carried out during the calibration routine depending on the trigger parameter and/or a stored algorithm.

In a particularly preferred and advantageous development, the device is designed as a steering input device. The steering input device serves in particular to input a steering command according to the steer-by-wire concept. The steering input device is provided in particular for a land vehicle and/or a watercraft and/or an aircraft. In particular, the operating element is designed as a steering unit or comprises at least one such unit. In the context of such a steering input device, the term “operating element” can then preferably be replaced by the term “steering unit”. The steering unit can comprise a steering wheel, a steering lever, an operating lever or another steering handle. The applicant reserves the right to claim such a steering control device.

Preferably, the calibration device is suitable and designed to carry out the calibration routine under the (necessary) condition that a vehicle that can be steered using the steering input device is in a suitable operating state. In particular, the suitable operating state is taken from a group of operating states, at least comprising: standstill; vehicle locked; vehicle exited; start routine running; switch-off routine running; outside mirrors folded in; charging process of an energy storage device; service mode.

Preferably, the calibration device is suitable and designed to end the calibration routine when the vehicle is no longer in the appropriate operating state. It is also possible that the appropriate operating state can only be ended when the calibration routine has been completely carried out. It is possible that a reference to the calibration routine is displayed during the calibration routine.

In particular, the condition that a suitable operating state must be present is also provided for other versions of the device. In particular, the calibration device is suitable and designed to carry out the calibration routine under the (necessary) condition that the device is in a suitable operating state.

In all embodiments, it is preferred that the calibration routine comprises at least one initialization. In particular, the initialization serves to establish operational readiness and/or calibration readiness. In particular, during the initialization, a defined operating state of the actuator device and/or the control device and/or the sensor device is set. As part of the initialization, in particular the control element is brought into a defined position. In particular, at least the braking device and the motor are initialized. In particular, a defined coil current and a defined motor current are set (can be equal to or not equal to zero). It is possible that an initialization phase is provided at the start of operation of the device. The initialization of the calibration routine can be integrated into this initialization phase or can take place independently of it. It is possible that at least part of the calibration routine takes place automatically as part of the initialization phase.

The method according to the invention serves to operate the vehicle component according to the invention or one of its embodiments. In particular, the method is designed such that the device described here can be operated accordingly. In particular, the method is designed such that it can also be used to carry out processes that the calibration device described here can carry out. In particular, the calibration device is suitable and designed to carry out the method and in particular its embodiments. In particular, the calibration device is suitable and designed to carry out the steps formulated in a method-like manner within the scope of the present invention. In particular, the calibration device comprises at least one algorithm for carrying out the steps described here.

In particular, the device comprises at least one sensor device. In particular, at least one characteristic parameter for the coil current and/or the braking torque of the braking device and/or for the motor current and/or the torque of the motor can be detected by means of the sensor device. In particular, the sensor device can comprise at least one characteristic parameter for the torque and/or the speed of the braking device. In particular, the sensor device comprises at least one sensor unit for detecting position information of the control element and, for example, the angle of rotation and/or the direction of rotation and/or the speed and/or the torque.

To control the braking device and the motor, the device preferably comprises at least one power electronics unit and/or at least one control device (Electronic Control Unit, ECU). In particular, the power electronics unit provides the coil current and/or the motor current. In particular, the power electronics unit is controlled by the control device. In particular, the calibration device is operatively connected to the control device and/or the power electronics unit. In particular, the calibration device can control the power electronics unit and/or the control device in order to supply the braking device with the required coil current and/or the motor with the required motor current for the calibration routine.

In particular, the calibration device specifies a motor current and/or a motor torque and/or a motor speed for providing the test torque. In particular, the calibration device specifies a coil current and/or a braking torque for providing the test state of the braking device. In the context of the present invention, a coil current or motor current is understood to mean not only a current or a current intensity, but also other parameters that are characteristic of a power supply. These can be, for example, a frequency of an alternating current or an alternating voltage or the like.

The device presented here can be designed to operate functions of a vehicle (e.g. rotary actuator with active adjustment by the motor) or of machines or devices (medical devices, computers, game controllers). The device presented here can be designed, for example, as a door drive, brake-by-wire actuator, seat adjustment and/or locking. In particular, the control element can then generally referred to as a movable device element. The device element can be designed, for example, as a lever or a shaft or the like. The applicant reserves the right to claim such a device.

The braking device comprises in particular at least one magnetorheological medium and in particular at least two brake components that can be moved (rotated) relative to one another. At least one circumferential gap is formed between the brake components. The magnetorheological medium is arranged in the gap, at least in sections. A controllable magnetic field can be generated by means of the coil device, which acts on the medium so that the rotational resistance of the brake components is changed and the braking torque is generated.

It is possible for the fault protection device to comprise at least one electrical coil device. This coil device can be provided in addition to or as an alternative to the permanent magnet device. In particular, the calibration routines presented here can then also be used for this coil device (e.g. the creation and/or adaptation of the assignment function or the characteristic curve).

The fault protection system uses in particular the magnetorheological medium and/or the gap of the braking device. It is also possible for the fault protection system to have its own magnetorheological medium and/or its own gap. In particular, the calibration routines presented here can then also be used for the magnetorheological medium of the fault protection system (e.g. the aging test).

Further advantages and features of the present invention will become apparent from the embodiments which are explained below with reference to the accompanying figures.

Shown here:

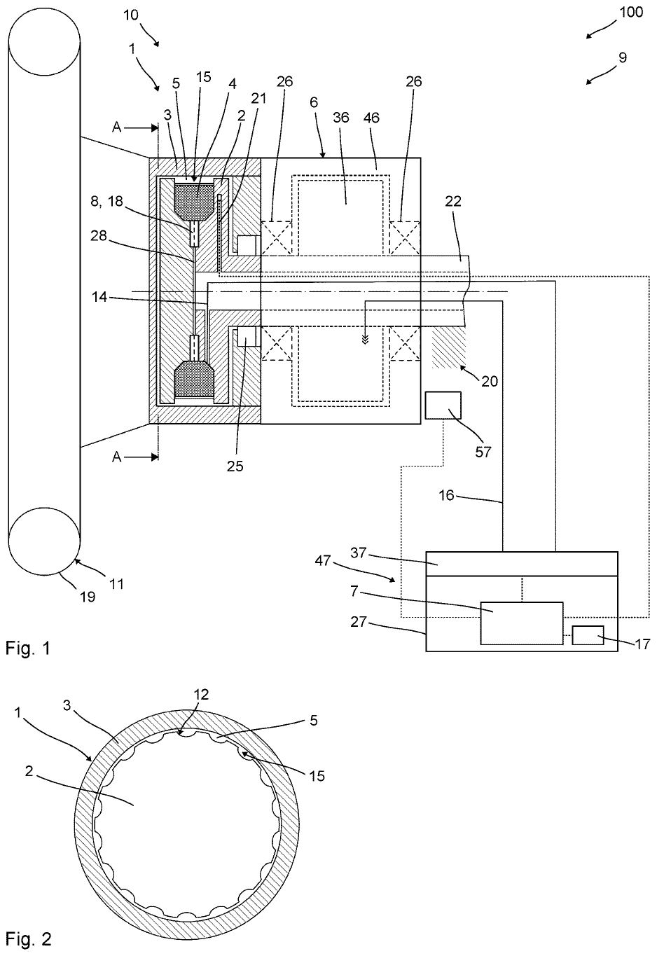

FIG. 1 is a purely schematic representation of a device according to the invention;

FIG. 2 is a detailed view of the device according to FIG. 1 in a sectioned view along the line A-A; and

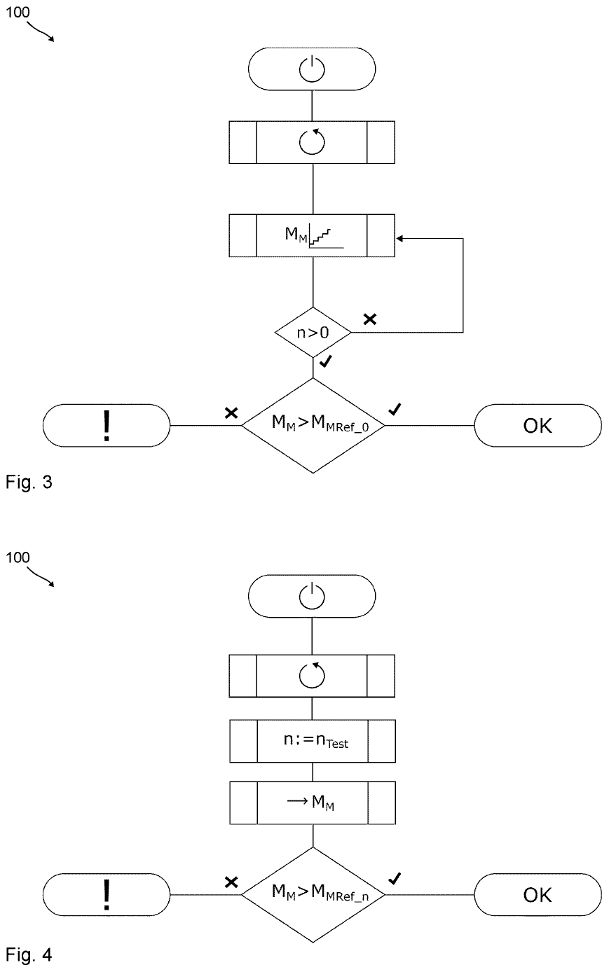

FIGS. 3-10 are purely schematic diagrams showing the functioning of the calibration device of the device according to the invention.

FIGS. 1 and 2 show a device 100 according to the invention with an actuator device 10 for the targeted influencing of the mobility of an operating element 11. The actuator device 10 comprises an (electric) motor 6 and a braking device 1 with two braking components 2, 3 that can be rotated relative to one another. The device 100 is operated here according to the method according to the invention.

The device 100 is designed here purely as an example as a steering input device 9 for specifying a steering command according to the steer-by-wire concept. For this purpose, the control element 11 is designed as a steering unit 9 and, for example, as a steering wheel. The design torques for the electric motor 6 are, for example, 0 to 5 Nm; for the braking device 1, for example, 0 to 20 Nm or 0 to 30 Nm.

The radially outer brake component 3 is rotatably mounted on an axle 22 by means of the bearings 26 and is coupled to the operating element 11 in a rotationally fixed manner. The radially inner brake component 2 is stationary and connected to the axle 22. The axle 22 is connected to a torque support 20 and, for example, to a body.

Between the brake components 2, 3 there is a circumferential gap 5 (so-called effective gap) in which a magnetorheological medium 15 is arranged. A controllable magnetic field can be generated with an electrical coil device 4. This influences the medium 15 in the gap 5 in such a way that the desired braking effect is generated between the brake components 2, 3. The braking device 1 can be used to specifically brake the control element 11 and provide haptic feedback. The coil device 4 is supplied with electrical energy via a power supply 14 running through the axis 22. The gap 5 is sealed with a seal 25.

As shown in the detailed illustration in FIG. 2, the gap 5 has a gap height that varies in the circumferential direction. For this purpose, the inner brake component 2 is equipped with a star contour 12. The star contour 12 has a sequence of elevations and depressions around the circumference. The elevations protruding into the gap 5 can be referred to as magnetic field concentrators. The magnetic field generated by the coil device 4 preferably runs over those areas of the gap 5 that have a smaller gap width (and thus in the area of the magnetic field concentrators). This makes it possible to achieve particularly high braking torques in combination with particularly compact dimensions. The outer brake component 3 here has an inner surface in the shape of a circular cylinder jacket.

To ensure that the operating element 11 cannot be rotated without resistance in the event of a fault, a fault protection device 8 with a permanent magnet device 18 designed as a ring magnet is provided here. The magnetic field of the permanent magnet device 18 acts on the medium 15 located in the gap 5 and thus generates the fault braking torque. In normal operation, the magnetic field of the permanent magnet device 18 is canceled out by a magnetic counterfield of the electrical coil device 4. To prevent a magnetic short circuit, an air gap 28 is formed radially inside the permanent magnet device 18, which serves as a magnetic flux barrier.

The control element 11 can be actively moved with the motor 6. The motor has a stator 36 which is firmly connected to the axis 22 and an external rotor 46. The stator 36 is a three-phase power supply 16 running through the axis 22. The rotor 46 is rotatably mounted on the axis 22 by means of the bearings 26.

The movement or position of the operating element 11 is detected here with a sensor device 47 with, for example, a rotation angle sensor 57. The braking device 1 is equipped here with a sensor unit 21 designed as a Hall sensor for measuring the magnetic field in the area of the gap 5.

The actuator device 502 is controlled and supplied with energy by a control device 27 (ECU) in combination with a power electronics device 37, taking into account the sensor signals. An algorithm and, for example, control software for the control device 27 is stored in a memory 17.

In order to optimally coordinate the braking device 1 and the motor 6, the device 100 is equipped with a calibration device 7, which can regularly carry out automatic calibration routines. For the calibration routine, the braking device 1 is placed in a defined test state. The motor 6 generates a defined test torque, which counteracts the braking device 1. For example, the level of the test torque at which the braking torque is overcome then provides parameters about the state of the braking device 1 and the fault protection 8. These parameters can then be used for calibration.

The calibration device 7 shown here can, for example: test or determine the emergency braking torque of the fault protection device 8; determine and calibrate the magnetic counter field of the coil device 4; carry out an aging test for the medium 15 and calibrate the braking device 1 depending on the state of the medium 15; determine and correct a characteristic curve which describes the relationship between a coil current and the braking torque that can be generated with the respective coil current. In the following, exemplary calibration routines which the calibration device 7 can carry out are presented with reference to FIGS. 3 to 10. The abbreviations in the figures mean:
I_{B}: test coil current of braking device 1 currently set for the test condition;
I_{BTest}: predefined test coil current for the test condition;
I_{BS}: Coil current for cancelling the emergency braking torque or for achieving the minimum braking torque M_{Bmin} (can also be referred to as cancellation coil current);
I_{M}: actual motor current;
M_{B}: actual braking torque (as a function of the coil current I_{B});
M_{BTest_min}: pre-defined minimum braking torque (at I_{Btest});
M_{Bmin}: minimum braking torque when the magnetic field of the accident protection device 8 is removed (achieved by energizing the coil device 4 with I_{BS});
M_{M}: actual motor torque (so-called test torque; as a function of the motor current I_{M});
M_{Mmax}: maximum engine torque;
M_{MRef_0}: stored reference value for the motor torque (reference torque) which is required to overcome the emergency braking torque from standstill;
M_{MRef_n}: stored reference value for the motor torque (reference torque) which is required to overcome the emergency braking torque at n_{Test};
n: speed measured at the control element 11 (motor 6 and braking device 1 also rotate);
n_{Test}: specification of motor speed for the emergency braking torque test or for tests at constant speed (so-called test speed).

FIG. 3 shows the calibration routine for a test of the emergency braking torque of the fault protection device 8. This proves the correct functioning of the emergency protection device 8 in the event of a complete power failure of the motor 6 and the braking device 1 and determines the emergency braking torque.

The calibration routine is started. An initialization follows: checking whether the motor 6 is active and de-energized; checking whether the coil device 4 is de-energized; initialization of the sensor device 47.

An iterative procedure follows: gradually increase the test torque M_{M} of the motor 6 until the sensor device 47 indicates a rotation of the control element 11 (n>0). The torque of the motor 6 is set via the motor current. The torque can be monitored, for example, based on a known torque constant (torque depending on the motor current) of the motor 6 or by a separate torque sensor.

If the engine torque that caused the control element 11 to rotate is greater than the predefined reference torque M_{MRef_0}, then the emergency protection 8 is OK and the emergency braking torque has been verified. Otherwise, there is an error and the emergency braking torque is too low. Then, for example, the driver is warned, the error is recorded and further travel may be prevented, etc.

FIG. 4 shows a variant of the calibration routine of FIG. 3, in which the measurement is not taken from a standstill, but the control element 11 is rotated at a defined test speed as part of the test. For this purpose, the engine speed is set to the test speed n_{Test} and the test torque M_{M} of the engine 6 is gradually increased and adjusted so that the test speed is never constant. If the test torque at which the speed is maintained is greater than the predefined reference torque M_{MRef_0}, then the accident protection 8 is in order and the accident braking torque is verified. The reference torque M_{MRefn} can be different to the M_{MRef_0} for the variant in FIG. 3, since there it is measured from standstill.

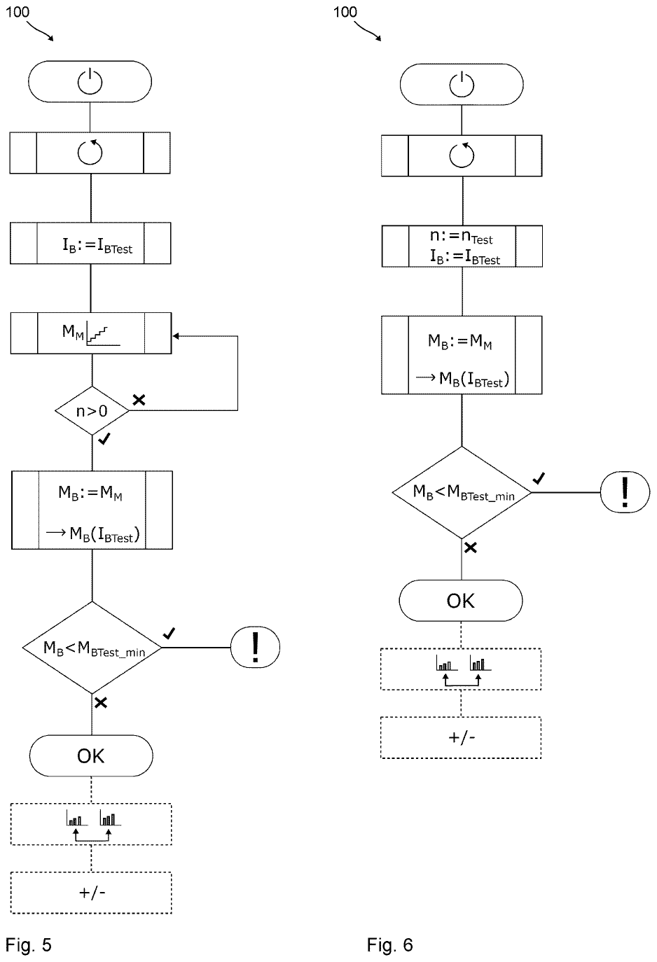

FIG. 5 shows the calibration routine for an aging test of the medium 15. This allows a changed braking effect of the medium to be detected and specifically compensated, e.g. by a defined increase in the coil current.

The calibration routine is started. An initialization follows: checking whether the motor 6 is active and de-energized; checking whether the coil device 4 is de-energized; initialization of the sensor device 47.

Then the coil device 4 is put into the test state and energized with a defined test coil current I_{BTEST}. This generates a (defined) braking torque.

An iterative procedure follows: gradually increase the test torque M_{M} of the motor 6 until the sensor device 47 indicates a rotation of the control element 11 (n>0). The torque of the motor 6 is set via the motor current.

If the control element 11 is rotated, a test parameter is calculated from the test torque M_{M}, which here corresponds to the braking torque M_{B}: M_{B} (L_{BTest}). This means that the braking torque resulting from the current supply with I_{BTest} is known. In principle, the respective braking torque for any coil current can also be calculated from this.

The test parameter can be compared with a stored comparison parameter. The comparison parameter here is a limit value for a minimum braking torque M_{BTest_min}, which must be reached at I_{BTest}. If the test parameter exceeds or reaches the comparison parameter, the aging state of the medium 15 is OK. Otherwise, an error has occurred. If necessary, a compensation parameter can then be calculated which specifically increases the coil current required for the requested braking torque. The test parameter can be stored in the memory 17 for long-term monitoring. In this way, the calibration device 7 can monitor a trend of aging or other signs of wear.

FIG. 6 shows a variant of the calibration routine of FIG. 5, in which the measurement is not taken from a standstill, but the control element 11 is rotated at a defined test speed as part of the test. To do this, the engine speed is set to the test speed n_{Test} and the test torque M_{M} of the engine 6 is increased step by step and adjusted so that the test speed n_{Test} is constant.

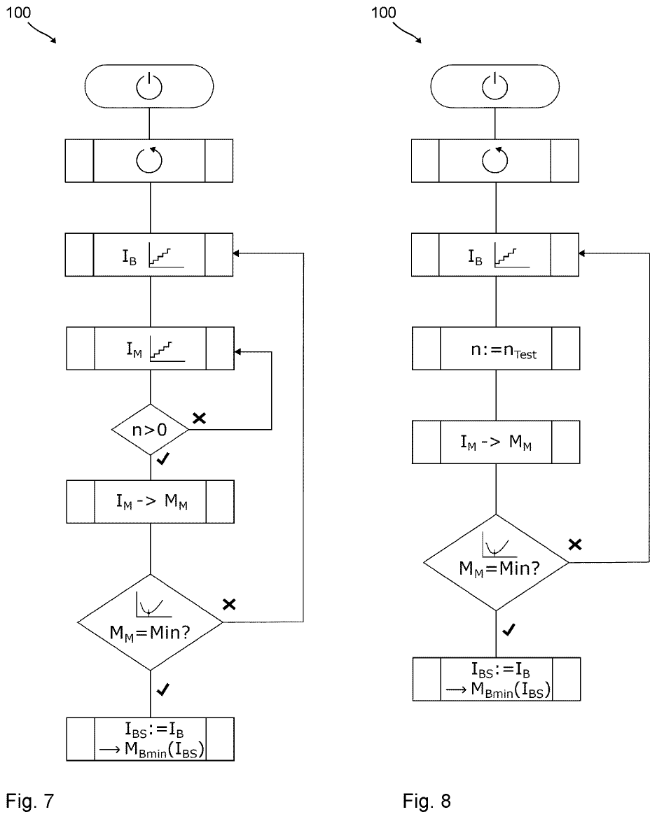

FIG. 7 shows the calibration routine for a test to determine the cancellation coil current of the coil device 4. In this case, the counter-field coil current is determined with which the effect of the permanent magnet device 18 of the emergency stop device 8 can be compensated or maximally canceled by means of an opposing field. For this purpose, the coil device 4 is supplied with “negative” current in order to be able to cancel the effect of the permanent magnet device 18. If a separate coil and (emergency) power supply are used for the emergency stop device 8, this procedure is not necessary.

The calibration routine is started. An initialization follows: checking whether the motor 6 is active and de-energized; checking whether the coil device 4 is de-energized; initialization of the sensor device 47.

Then the coil device 4 is put into the test state. For this purpose, the counter-field coil current or coil current I_{B} is set to 0 amperes so that the coil device 4 is de-energized.

An iterative procedure follows: Gradually increase the test torque M_{M} of motor 6 until the sensor device 47 indicates rotation of the control element 11 (n>0). The torque of motor 6 is adjusted via the motor current. If rotation of the control element 11 is detected, a check is made to determine whether the test torque is less than a test torque determined immediately before. If it is the first test torque determined, at least one additional test torque is determined.

If the test torque is smaller than the test torque determined immediately before, the value of the test torque and the associated counter-field coil current are registered. This is followed by an iteration of the corresponding previous steps, each with a defined increase in the counter-field coil current. In other words, as long as the braking effect can be overcome with lower test torques using an increased counter-field coil current, the measurement continues iteratively.

If the test torque is greater than the test torque determined immediately before, the test torque currently determined is discarded. Increasing the counter-field coil current therefore no longer makes it easier to overcome the braking effect. The test torque determined previously is then registered as the base torque with the associated counter-field coil current as the cancellation coil current. The iteration is terminated. The cancellation coil current is therefore the coil current I_{B} at which the base torque or a minimum braking torque M_{Bmin} is present. The data thus obtained can then be stored in the control device 27 and used to control the braking device 1.

FIG. 8 shows a variant of the calibration routine of FIG. 7, in which the measurement is not taken from a standstill, but the control element 11 is rotated at a defined test speed as part of the test. To do this, the engine speed is set to the test speed Test and the test torque M_{M} of the engine 6 is increased step by step and adjusted so that the test speed is never constant.

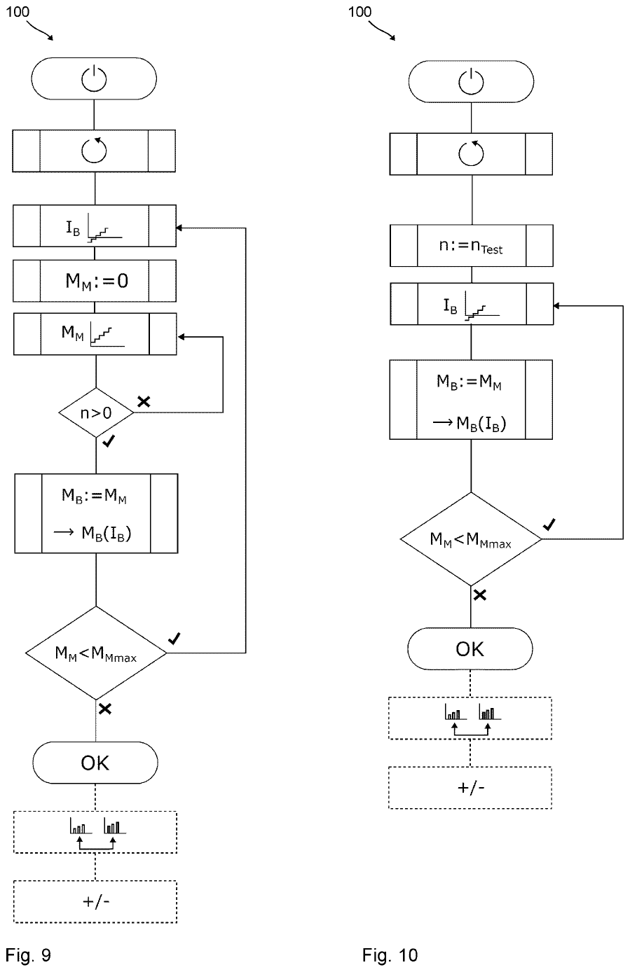

FIG. 9 shows a calibration routine for creating a characteristic curve for the braking device 1, which assigns a coil current to each required braking torque. The characteristic curve can only be recorded up to the maximum motor torque. For areas above this, an extrapolation or another suitable method can then be used.

The calibration routine is started. An initialization follows: checking whether the motor 6 is active and de-energized; checking whether the coil device 4 is de-energized; initialization of the sensor device 47.

The coil device 4 is then put into the test state and energized with a defined test coil current I_{B} so that a test braking torque is generated. The test coil current can be set so that the opposing field is generated and the test is based on the base torque. The torque M_{M} of the motor 6 is set to 0.

An iterative procedure follows: gradually increase the test torque M_{M} of the motor 6 until the sensor device 47 indicates a rotation of the control element 11 (n>0). The torque of the motor 6 is set via the motor current. If there is a rotation of the control element 11, the torque M_{M} is calculated from the current motor current I_{M}. The braking torque is calculated from the torque M_{M}.

The test braking torque is then increased step by step by increasing the test coil current I_{B}. For each increase in the test braking torque, the previous steps are iterated. This records a large number of test braking torques and associated test torques, from which the characteristic curve M_{B} (I_{B}) is determined. The iteration continues until M_{Max} is reached.

The characteristic curve can then be made available to the control device 47 for controlling the coil device 4. The characteristic curve can also be used to adapt an existing characteristic curve or to calculate compensation functions. It is also possible to compare with historical data to identify a trend.

FIG. 10 shows a variant of the calibration routine of FIG. 9, in which the measurement is not taken from a standstill, but the control element 11 is rotated at a defined test speed as part of the test. For this purpose, the motor speed is set to the test speed n_{Test} and the test torque M_{M} of the motor 6 is gradually increased and adjusted so that the test speed is never constant.

List of Reference Symbols:

| | |
|---|---|
| 1 | Braking device |
| 2 | Braking component |
| 3 | Braking component |
| 4 | Coil device |
| 5 | Gap |
| 6 | Motor |
| 7 | Calibration device |
| 8 | Failure protection device |
| 9 | Steering input device |
| 10 | Actuator device |
| 11 | Control element |
| 12 | Star contour |
| 14 | Power supply |
| 15 | Medium |
| 16 | Power supply |
| 17 | memory |
| 18 | Permanent magnet device |
| 19 | Steering unit |
| 20 | Torque support |
| 21 | Sensor unit |
| 22 | Axle |
| 25 | Seal |
| 26 | Bearing |
| 27 | Control device |
| 28 | Air gap |
| 36 | Stator |
| 37 | Power electronics |
| 46 | Rotor |
| 47 | Sensor device |
| 57 | Angle sensor |
| 100 | Device |

1-23. (canceled)

24. A device, comprising:
a movable operating element and an actuator for selectively influencing a mobility of said operating element, said actuator having:
at least one magnetorheological brake with at least one electrical coil for generating a braking torque acting on said operating element, said brake being configured to selectively brake said mobility of said operating element;
at least one electric motor for generating a torque acting on said operating element, said electric motor being configured to actively move said operating element;
at least one calibrator configured to coordinate said braking torque of said brake and said torque of said motor within a framework of at least one automated calibration routine; and
said calibrator being configured to place said brake into a defined test state, to generate at least one test torque via said motor counteracting said brake, and to record at least one parameter that characterizes an effect of said test torque on said mobility of said operating element.

25. The device according to claim 24, wherein said defined test state of said brake is at least one test state selected from a group including:
a test state for a fault protection device;
a test state for an aging test for a magnetorheological medium of said brake;
a test state for determining a cancelation coil current for canceling a fault protection braking torque of a fault protection device; and
a test state for detecting an assignment function that describes a relationship between a coil current and said braking torque.

26. The device according to claim 24, wherein said calibrator is configured to perform at least the following steps during said calibration routine:
bring said motor to a standstill or to a test speed;
activate a test state in which said electrical coil is in a de-energized state;
drive said motor to generate a test torque;
check whether said test torque is sufficient to move said control element from a standstill or to maintain said test speed;
if said test torque is insufficient, increase said test torque and re-check whether said test torque is sufficient;
if said test torque is sufficient, compare said test torque with a reference torque;
if said test torque exceeds said reference torque, classify a fault protection device as OK; and
if said test torque falls below said reference torque, classify said fault protection device as not OK.

27. The device according to claim 26, wherein said calibrator is configured to store a test torque tested to be sufficient in a memory and to compare said test torque tested to be sufficient with further test torques stored in said memory with one another.

28. The device according to claim 24, wherein said calibrator is configured to perform at least the following steps during said calibration routine:
bring said motor to a standstill or to a test speed;
activate a test state in which said electrical coil is energized with a defined test coil current;
drive said motor to generate a test torque;
checking whether said test torque is sufficient to move said control element from a standstill or to maintain said test speed;
if said test torque is insufficient, increase said test torque and recheck whether said test torque is sufficient;
if said test torque is sufficient, compare a test parameter corresponding to said test torque and/or a parameter calculated from said test torque with a comparison parameter;
if said test parameter exceeds said comparison parameter, classify a condition of said brake as OK; and
if said test parameter falls below said comparison parameter, classify said condition of said brake as not OK.

29. The device according to claim 28, wherein said calibrator is configured to store said test parameter in a memory and to compare said test parameter and further test parameters stored in said memory with one another.

30. The device according to claim 28, wherein said calibrator is configured to determine at least one compensation parameter as a function of said test parameter and to control said electrical coil based on said compensation parameter, and said compensation parameter corrects a relationship between a coil current and said braking torque.

31. The device according to claim 24, further comprising:
at least one fault protection device with at least one permanent magnet;
said permanent magnet being configured to provide a magnetic field which generates an emergency braking torque acting on said operating element;
said magnetic field of said permanent magnet being reduced during normal operation by a magnetic counter-field of said electrical coil, such that said emergency braking torque is at least partially canceled;
said counter-field being generated by driving said coil with a defined cancellation coil current;
said calibrator being configured to set a plurality of different counter-field coil currents during said calibration routine and to iteratively determine and register a test torque for each of said set counter-field coil currents, at which said operating element is set in motion from a standstill or at which said test speed is maintained; and
said calibrator being configured to determine, from said set counter-field coil currents and said registered test torques, said counter-field coil current at which said lowest test torque is present, and to register this counter-field coil current as said cancellation coil current.

32. The device according to claim 31, wherein said calibrator is configured to:
gradually increase said counter-field coil current starting from an initial value and to determine a test torque for each increased counter-field coil current;
to repeat this iteration as long as said determined test torques decrease; and
terminate this iteration when a test torque that is increased compared to a previously determined test torque is determined at least once.

33. The device according to claim 32, wherein said calibrator is configured to perform at least the following steps:
setting said initial value of said counter-field coil current;
bringing said motor to a standstill or to a test speed;
controlling said motor to generate a test torque;
checking whether said test torque is sufficient to move said control element from a standstill or to maintain said test speed;
if said test torque is insufficient, increasing said test torque and rechecking whether said test torque is sufficient;
if said test torque is sufficient and this is said first test torque determined, iterate with a defined increase in said counter-field coil current until at least two test torques are determined;
if said test torque is sufficient and not said first test torque determined, check whether said test torque is less than a test torque determined immediately before;
if said test torque is less than said test torque determined immediately before, record said test torque value and said corresponding counter-field coil current and iterate at least some previous steps of said calibration routine with a defined increase in said counter-field coil current; and
if said test torque is greater than said test torque determined immediately before, discard the determined test torque and register said previously determined test torque as said base torque with an associated counter-field coil current as said cancellation coil current, and end said iteration.

34. The device according to claim 31, wherein said calibrator is configured to register said cancelation coil current and to at least partially use it for canceling said emergency braking torque during normal operation.

35. The device according to claim 31, wherein said calibrator is configured to store said cancellation coil current in a memory and to compare said cancellation coil current and further cancelation coil currents stored in said memory with one another.

36. The device according to claim 31, wherein said calibrator is configured to perform at least the following steps during said calibration routine:
bring said motor to a standstill or to a test speed;
activate a test state by energizing said electrical coil with a defined test coil current resulting in a test braking torque;
drive said motor to generate a test torque;
check whether said test torque is sufficient to move said control element from a standstill or to maintain said test speed;
if said test torque is insufficient, increase said test torque and recheck whether said test torque is sufficient;
if said test torque is sufficient, use said test torque to create and/or adjust an assignment function that describes a relationship between a coil current and said braking torque.

37. The device according to claim 36, wherein said calibrator is configured to gradually increase said test braking torque of said electrical coil and to perform an iteration of at least a portion of preceding steps of said calibration routine for each of said set test braking torques, thereby recording a plurality of test braking torques and associated test torques and determining therefrom a characteristic curve that describes the relationship between said coil current and said braking torque.

38. The device according to claim 37, wherein said iteration is performed until a maximum motor torque is reached.

39. The device according to claim 36, wherein said calibrator is configured to store said assignment function and to compare said assignment function and further assignment functions stored in said memory with one another.

40. The device according to claim 36, wherein said calibrator is configured to use said assignment function to calculate compensation functions, such that said assignment function can be adapted to compensate for changes.

41. The device according to claim 24, wherein said calibrator is suitable and configured to adjust at least one control variable, preferably an assignment function and/or characteristic curve, based on data acquired during said calibration routine, wherein said control variable is stored in a controller and serves to control said actuator.

42. The device according to claim 24, wherein said calibrator is configured to determine a torque provided by said motor by an assignment function that describes a relationship between a motor current and said torque that can be provided by said motor with a respective motor current.

43. The device according to claim 24, wherein said calibrator is configured to automatically perform said calibration routine as a function of a trigger parameter, and said trigger parameter is taken from a group of trigger parameters including:
an operating state of the device;
a start and/or termination of an operation and/or a function of the device;
a time;
an interval;
a number of operating hours;
a presence of a fault;
a command from a controller; and
an input command from a user.

44. The device according to claim 24, configured as a steering input for inputting a steering command according to the steer-by-wire concept, wherein said control element is configured as, or is, a steering unit.

45. The device according to claim 44, wherein said calibrator is configured to perform said calibration routine under a condition that a vehicle steerable by said steering input is in a suitable operating state, and said suitable operating state is taken from a group of operating states at least including:
said vehicle is at a standstill;
said vehicle is locked;
said vehicle has been exited;
a start-up routine of said vehicle is running;
a switch-off routine of said vehicle is running;
exterior mirrors of said vehicle are folded in;
an active charging process of an energy storage of said vehicle; and
a service mode of said vehicle.

46. A method for operating a device according to claim 24.
